(19) United States
(12) Patent Application Publication
(10) Pub. No.: US 2026/0273904 A1
(43) Pub. Date: Sep. 17, 2026

(54) Flame-Retardant Decorative Laminate and Decorative Article Including the Laminate

(71) Applicant: 3M INNOVATIVE PROPERTIES COMPANY, St. Paul, MN (US)

(72) Inventors: Shinsuke Kondo, Higashine-City (JP); Katsuya Ono, Tendo-City (JP); Naota Sugiyama, St. Paul, MN (US); Keisuke Kato, Yamagata-shi (JP)

(21) Appl. No.: 19/480,221

(22) PCT Filed: May 10, 2024
(86) PCT No.: PCT/IB2024/054571

§ 371 Date: Oct. 30, 2025

(30) Foreign Application Priority Data
May 26, 2023 (JP) 2023-086987

(51) Int. Cl. B32B 27/20; B32B 27/08; B32B 27/30; B32B 27/36

(52) U.S. Cl. CPC B32B 27/20; B32B 27/08; B32B 27/304; B32B 27/36; B32B 2250/02; B32B 2250/24; B32B 2264/10; B32B 2305/70; B32B 2307/3065; B32B 2307/7376; B32B 2451/00

(57) ABSTRACT

Provided is an environmentally-friendly decorative laminate having excellent flame retardancy, and a decorative article including the laminate. A flame-retardant decorative laminate includes a substrate, a colored layer, and an adhesive layer. The colored layer contains a biomass-derived extender pigment and contains about 15 mass % or more of at least one selected from the group consisting of a phosphorus-based flame retardant and a boron-based flame retardant.

### TECHNICAL FIELD

The present disclosure relates to a flame-retardant decorative laminate and a decorative article including the laminate.

### BACKGROUND ART

Decorative sheets having, for example, flame retardancy, have been developed and used in a wide variety of fields. Such known decorative sheets are used in a wide range of fields such as interior products or exterior products.

Patent Document 1 (JP 2015-182379 A) describes a decorative sheet in which a substrate sheet, a transparent resin layer and a surface protective layer are laminated in this order, in which (1) the substrate sheet contains a resin component and a flame retardant, (2) the content of the flame retardant is from 10 to 100 parts by mass with respect to 100 parts by mass of the resin component, (3) the thickness of the substrate sheet is from 15 to 150 μm, (4) the thickness of the transparent resin layer is from 15 to 150 μm, and (5) the total thickness of the substrate sheet, the transparent resin layer, and the surface protective layer is from 40 to 200 μm.

Patent Document 2 (JP 2017-177527 A) describes a decorative sheet including a substrate film having thermal foaming properties and an adhesive layer provided on at least one side of the substrate film, in which in a Heat Release Test mentioned below in which a laminate including a plasterboard and the decorative sheet laminated on a side to which radiant heat is applied of the plasterboard is used as a test piece, the test piece has a total calorific value of 7.2 MJ/m² or less during a test time of 20 minutes:

Heat Release Test: heat release test according to ISO 5660-1:2002, cone calorimetry, in which the total calorific value is measured under a condition that radiant heat applied to a test piece surface is 50 kW/m².

It is known that an inorganic material such as calcium carbonate may have performance as a flame retardant as described in the item of Background art of Patent Document 3 (JP 2021-044191 A), for example.

### CITATION LIST

### Patent Document

Patent Document 1: JP 2015-182379 A
Patent Document 2: JP 2017-177527 A
Patent Document 3: JP 2021-044191 A

### SUMMARY OF INVENTION

### Technical Problem

In recent years, in the background of environmental problems and the like, materials in consideration of environmental problems have been used as materials constituting decorative laminates. As described in Patent Document 3, since an inorganic material such as calcium carbonate also has a performance as a flame retardant, it has been expected that a decorative laminate having flame retardancy in consideration of environmental problems can be obtained by using a biomass-derived extender pigment as a pigment to be blended in a colored layer of the decorative laminate. However, using a biomass-derived extender pigment makes it difficult to exhibit flame retardancy required in recent years in decorative laminates.

The present disclosure provides an environmentally-friendly decorative laminate having excellent flame retardancy, and a decorative article including the laminate.

### Solution to Problem

According to an embodiment of the present disclosure, provided is a flame-retardant decorative laminate including a substrate, a colored layer, and an adhesive layer, in which the colored layer contains a biomass-derived extender pigment and contains about 15 mass % or more of at least one selected from the group consisting of a phosphorus-based flame retardant and a boron-based flame retardant.

According to another embodiment of the present disclosure, a decorative article including a support member and the decorative laminate bonded to the support member is provided.

### Advantageous Effects of Invention

According to the present disclosure, an environmentally-friendly decorative laminate having excellent flame retardancy, and a decorative article including the laminate can be provided.

The above description should not be construed as disclosing all embodiments of the present invention and all advantages relating to the present invention.

### DESCRIPTION OF EMBODIMENTS

Hereinafter, the present disclosure will be described in more detail for the purpose of illustrating representative embodiments according to the present disclosure, but the present disclosure is not limited to these embodiments.

In the present disclosure, the term “on”, for example used in “a colored layer is disposed on an adhesive layer” means that the colored layer is disposed directly on the upper side of the adhesive layer, or that the colored layer is indirectly disposed on the upper side of the adhesive layer via another layer.

In the present disclosure, the term “under”, for example used in “a colored layer is disposed under a substrate” means that the colored layer is disposed directly under the lower side of the substrate, or that the colored layer is indirectly disposed under the lower side of the substrate via another layer.

In the present disclosure, “transparent” refers to an average transmittance in a visible light region (wavelength of from 400 nm to 700 nm) measured in accordance with JIS K 7375 of about 80% or more, and the average transmittance may be desirably about 85% or more, or about 90% or more. An upper limit of the average transmittance is not particularly limited, and can be, for example, about less than 100%, about 99% or less, or about 98% or less.

In the present disclosure, “translucent” refers to an average transmittance in a visible light region (wavelength of from 400 nm to 700 nm) measured in accordance with JIS K 7375 of about less than 80%, and the average transmittance may be desirably about 75% or less, and “translucent” is intended to mean that an underlying layer is not completely hidden.

In the present disclosure, the term “(meth)acrylic” refers to acrylic or methacrylic, and the term “(meth)acrylate” refers to acrylate or methacrylate.

In the present disclosure, the term “film” may encompass articles referred to as “sheets”.

Hereinafter, for the purpose of illustrating representative embodiments of the flame-retardant decorative laminate of the present disclosure, details of each component will be described.

A flame-retardant decorative laminate of the present disclosure (it may be simply referred to as “laminate” or “decorative laminate”) includes a substrate, a colored layer, and an adhesive layer, in which the colored layer contains a biomass-derived extender pigment and contains about 15 mass % or more of at least one selected from the group consisting of a phosphorus-based flame retardant and a boron-based flame retardant.

The inventors of the present invention have found that when a specific flame retardant is blended, that is, a flame retardant in which at least one selected from the group consisting of a phosphorus-based flame retardant and a boron-based flame retardant is blended in an amount of about 15 mass % or more with respect to a colored layer together with a biomass-derived extender pigment is blended, an environmentally-friendly decorative laminate having good flame retardancy can be obtained.

The flame retardancy of the laminate may be evaluated, for example, by a heat release test according to ISO 5660-1:2002, cone calorimetry, in which the total calorific value (may be simply referred to as “THR”) is measured under a condition that radiant heat applied to a test piece surface is 50 kW/m². Here, as the test piece used in the test, a laminate plate including a plasterboard and a decorative laminate laminated on a side of the plasterboard to which radiant heat is applied is used. In some embodiments, the flame-retardant decorative laminate of the present disclosure can provide such a test piece with a total calorific value of about 8.0 MJ/m² or less, less than about 8.0 MJ/m², about 7.9 MJ/m² or less, about 7.8 MJ/m² or less, about 7.7 MJ/m² or less, about 7.6 MJ/m² or less, or about 7.5 MJ/m² or less during a test time of 20 minutes. The lower limit of the total calorific value is not particularly limited, and it may be, for example, about 4.0 MJ/m² or more, about 4.5 MJ/m² or more, about 5.0 MJ/m² or more, about 5.5 MJ/m 2 or more, or about 6.0 MJ/m 2 or more.

In some embodiments, the flame-retardant decorative laminate of the present disclosure may have a maximum heat release rate (sometimes referred to simply as “PHRR”) of about 240 kW/m² or less, about 220 kW/m² or less, about 200 kW/m² or less, about 190 kW/m² or less, or about 180 kW/m² or less as determined by the heat release test described later. The lower limit of the maximum heat release rate is not particularly limited, and it may be, for example, about 100 kW/m² or more, about 110 kW/m² or more, or about 120 kW/m² or more.

In some embodiments, the flame-retardant decorative laminate of the present disclosure may have a time to exceed 200 kW/m² of less than about 10.0 seconds, about 9.0 seconds or less, about 7.0 seconds or less, about 5.0 seconds or less, about 3.0 seconds or less, or about 1.0 second or less with respect to the heat release rate as determined by the heat release test described later. The lower limit of such time is not particularly limited, but it may be, for example, about 0 seconds or more or more than about 0 seconds.

The thickness of the flame-retardant decorative laminate of the present disclosure is preferably, for example, about 200 micrometers or less, about 190 micrometers or less, about 180 micrometers or less, about 175 micrometers or less, or about 170 micrometers or less from the viewpoint of flame retardancy. The lower limit of the thickness is not particularly limited, and it may be, for example, about 100 micrometers or more, about 110 micrometers or more, or about 120 micrometers or more. Here, the thickness of the laminate refers to the thickness of the laminate in a state of being applied to an adherend, and for example, when a release liner is applied to the laminate, the thickness of the laminate excluding the liner is intended.

The substrate of the present disclosure may be used as a member that supports a colored layer, an adhesive layer, and any layer (for example, a surface layer) constituting a decorative laminate.

The substrate is not particularly limited, and for example, a substrate containing at least one selected from the group consisting of a polyester resin (for example, polyethylene terephthalate resin, polyethylene naphthalate resin, or polybutylene terephthalate resin), a vinyl chloride resin, a resin having a urethane bond, a polyolefin resin, a polycarbonate resin, a (meth)acrylic resin, a cellulose resin, a polylactic acid resin, and a fluororesin may be used. Here, in the present disclosure, the term “resins having urethane bonds” may include, for example, a resin prepared using at least one selected from urethane (meth)acrylate and urethane (meth)acrylate oligomer besides a urethane resin, and the urethane resin can also include a (meth)acrylic urethane resin, and the like.

Of these, a polyester resin is preferable, and a polyethylene terephthalate resin (it may be simply referred to as “PET resin”) is more preferable. The substrate containing such a resin can contribute to improvement in performance such as strength (for example, flexibility and resistance to breakage) of the decorative laminate. On the other hand, a PET resin, particularly a recycled PET resin described below, is a resin that is more flammable than a vinyl chloride resin used as a material for a substrate constituting a known decorative laminate. Thus, it is typically difficult to impart flame retardancy to a decorative laminate including a substrate containing a PET resin. The decorative laminate of the present disclosure includes a colored layer containing a biomass-derived extender pigment and containing about 15 mass % or more of at least one selected from the group consisting of a phosphorus-based flame retardant and a boron-based flame retardant. Thus, the decorative laminate can exhibit excellent flame retardancy even when a PET resin is used as the material of the substrate.

The substrate of the present disclosure may contain the PET resin in an amount of about 50 mass % or more, about 70 mass % or more, or about 90 mass % or more with respect to the total amount of the resin components of the substrate, or all the resin components of the substrate may be the PET resin.

The surface of the substrate may be subjected to surface treatment such as corona treatment, plasma treatment, or primer treatment.

The thickness of the substrate is not particularly limited, and is, for example, preferably about 10 micrometers or more, about 20 micrometers or more, about 30 micrometers or more, or about 40 micrometers or more from the viewpoint of the strength, handleability, and the like of the decorative laminate. The upper limit of the thickness is not particularly limited, and is, for example, preferably about 180 micrometers or less, about 150 micrometers or less, about 100 micrometers or less, about 80 micrometers or less, or about 60 micrometers or less from the viewpoint of flame retardancy. The thicknesses of the respective layers in the flame-retardant decorative laminate of the present disclosure may be defined, for example, as the mean value of the thicknesses measured at at least any five points on the substrate with a thickness gauge (PC-465N manufactured by TECLOCK Co., Ltd.). When the layer constituting the laminate is thin and it is difficult to measure the thickness with a thickness gauge, a cross section in a thickness direction of the laminate configuration is measured using a scanning electron microscope, and the thickness can be defined as an average value of thicknesses of at least any five points in a target layer, for example, a surface layer, of the laminate configuration.

In some embodiments, the substrate of the present disclosure includes recycled PET resin as the PET resin. The substrate of the present disclosure including a recycled PET resin can further contribute to the provision of an environmentally-friendly decorative laminate.

The substrate of the present disclosure may contain the recycled PET resin in an amount of about 10 mass % or more, about 30 mass % or more, about 50 mass % or more, about 70 mass % or more, or about 90 mass % or more with respect to the total amount of the PET resin components in the substrate, or all of the PET resin components may be the recycled PET resin. The proportion of the recycled PET resin component contained in the recycled PET resin may be about 50 mass % or more, about 70 mass % or more, or about 90 mass % or more, and about 100 mass % or less, or less than about 100 mass %, with respect to the total amount of the PET resin components constituting the recycled PET resin. The term “recycled PET resin” as used herein means PET resin containing recycled PET resin components, and may be either mechanically recycled PET resin or chemically recycled PET resin. The term “mechanically recycled PET resin” refers to PET resin obtained by subjecting recovered products from used molded products and waste materials to fractionation, pulverization, washing, filtration in a molten state, extraction with organic solvents, heat treatment under reduced pressure, and the like, and the term “chemical recycled PET” refers to PET resin regenerated by further depolymerizing and the like.

The difference between recycled PET resin and virgin PET resin may be evaluated by using, for example, a differential scanning calorimeter (DSC). Recycled PET resin contains impurities as compared with virgin PET resin, or contains a copolymerization component (for example, isophthalic acid) depending on the type of the molded article from which the recycled PET resin is recovered, and thus typically has a lower melting point as compared with virgin PET resin. Recycled PET resin has, for example, a melting point (peak top) of about 250±about 5° C. calculated from the second heating curve by DSC, which is lower by about 2 to about 3° C. than the melting point of virgin PET resin calculated in the same manner.

As the recycled PET resin, a regenerated raw material of a PET bottle may be used. Such a regenerated raw material is a polyester produced and molded by a typical polymerization method and a solid phase polymerization method, and is preferably mainly composed of polyethylene terephthalate, and may contain other polyester components and copolymerization components. The regenerated raw material may contain a metal compound such as antimony, germanium or titanium as a catalyst, a phosphorus compound as a stabilizer, or the like. Since germanium is commonly used as a catalyst in polyesters for PET bottles, a substrate prepared using a PET bottle regenerated material may contain germanium in an amount of about 1 ppm or more, or about 3 ppm or more, and about 100 ppm or less, or about 50 ppm or less with respect to the total amount of the substrate. Thus, the use of recycled PET resin can be evaluated by examining the amount of germanium in the substrate. Here, the content of germanium in the substrate can be measured by the following analysis method: (Analysis Method for Germanium)

A sample in an amount of 2 g is subjected to ashing decomposition in a platinum crucible, 5 ml of a 10% sodium hydrogen carbonate solution is added thereto and evaporated, and hydrochloric acid is further added thereto and evaporated to dryness. The temperature is raised from 400° C. to 950° C. in an electric furnace, and the material is left for 30 minutes to melt. The obtained material is dissolved in 10 ml of water by heating and transferred to a germanium distillation apparatus (water washing 7.5 ml×2). Hydrochloric acid in an amount of 35 ml is added, and distillation is performed to collect 25 ml of distillate. An appropriate amount is taken out from the distillate, and hydrochloric acid is added thereto to have a final concentration of from 1 mol/L to 1.5 mol/L. A 0.25% polyvinyl alcohol solution in an amount of 2.5 ml, 2.5 ml of a 1% cetyltrimethylammonium chloride solution, and 5 ml of a 0.04% phenylfluorone (2,3,7-trihydroxy-9-phenyl-6-fluorone) solution are added and made up to 25 ml with water. A yellow complex is formed with germanium, and the absorption at 505 nm is measured with an absorptiometer (UV-150-02 manufactured by Shimadzu Corporation) to perform colorimetry.

Typically, the regenerated raw material of the PET bottle may be subjected to alkali washing using a sodium hydroxide solution and/or a potassium hydroxide solution in production stage of the regenerated raw material. As a result, the regenerated raw material may contain sodium and/or potassium in an amount of more than 0 ppm, about 3 ppm or more, or about 5 ppm or more, about 150 ppm or less, about 120 ppm or less, or about 80 ppm or less. Thus, the use of the recycled PET resin can also be evaluated by examining the amount of sodium and/or the amount of potassium in the substrate. Here, the amount of sodium and/or the amount of potassium in the substrate can be measured by the following analysis method:

### (Analytical Method for Sodium and Potassium)

The substrate is molded into a disk shape with a thickness of about 5 mm on a smooth metal plate, and the smooth surface is measured with a fluorescent X-ray analyzer. The calibration curve is prepared by using a standard sample whose concentration has been confirmed in advance by an emission plasma analysis method.

The substrate of the present disclosure may contain, fillers, reinforcing materials, antioxidants, UV absorbing agents, flame retardants, light stabilizers, heat stabilizers, dispersants, plasticizers, flow improvers, surfactants, leveling agents, silane coupling agents, catalysts, pigments, and dyes as optional components in a range that does not negatively affect the effect of the present disclosure. The optional components may be used alone or in combination of two or more types. The individual compounded amount and total compounded amount of the optional components can be decided in a range that does not impair the characteristics required for the substrate.

In some embodiments, in the substrate of the present disclosure, the compounded amount of a flame retardant in the substrate is about 10 mass % or less, about 5 mass % or less, about 3 mass % or less, about 1 mass % or less, or about 0.5 mass % or less, or the substrate of the present disclosure is free of flame retardant. Since the substrate containing the flame retardant at such a ratio or containing no flame retardant is excellent in transparency, it is possible to reduce or suppress deterioration of decorative performance due to the colored layer or the like disposed on or under the substrate. Since the decorative laminate of the present disclosure includes the colored layer containing the biomass-derived extender pigment and containing about 15 mass % or more of at least one selected from the group consisting of a phosphorus-based flame retardant and a boron-based flame retardant, the decorative laminate can exhibit excellent flame retardancy even when the compounded amount of the flame retardant in the substrate is low or no flame retardant is contained in the substrate.

The colored layer of the present disclosure contains a biomass-derived extender pigment and contains about 15 mass % or more of at least one selected from the group consisting of a phosphorus-based flame retardant and a boron-based flame retardant. The colored layer may be a layer that is colored, may be transparent or semi-transparent, or may be opaque, that is, may have concealing performance. The colored layer may be, for example, a layer exhibiting a light color such as white or yellow, or a dark color such as red, brown, green, blue, gray, or black. The colored layer may be partially applied to the decorative laminate, but is preferably applied to the entire surface of the decorative laminate from the viewpoint of flame retardancy. The decorative layer may have a single layer structure or a layered structure. The colored layer may be applied directly or indirectly to one or both surface of the substrate described above.

The colored layer may be applied directly or indirectly to one or both surface of the substrate described above. The application method to the substrate is not particularly limited, and known methods such as knife coating, bar coating, blade coating, doctor coating, roll coating, and cast coating may be used.

In the present disclosure, the term “biomass-derived extender pigment” refers to an extender pigment produced using, as a raw material, biomass intended as a renewable resource produced from animals and plants. Such a biomass-derived extender pigment may be an extender pigment prepared using a biomass-derived raw material as all of its raw materials, or may be an extender pigment prepared using a biomass-derived raw material as at least a part of its raw materials. That is, when a biomass-derived raw material is used as at least a part of the raw material of the extender pigment, the extender pigment may contain a biomass component in an amount of about 50 mass % or more, about 70 mass % or more, or about 90 mass % or more, and less than about 100 mass %, or about 95 mass % or less, with respect to the total amount of the components constituting the extender pigment. The biomass-derived extender pigment may be used alone or in combination of two or more types.

The biomass as a raw material is not particularly limited, and for example, shells of scallops and oysters, eggshells, woody materials, and the like may be employed. From the viewpoint of flame retardancy, the biomass-derived extender pigment preferably contains a biomass-derived inorganic extender pigment (for example, calcium carbonate, silicon dioxide, and calcium oxide), and more preferably contains a biomass-derived calcium carbonate. As such extender pigments, for example, products such as scallop powder, oyster shell nanopowder, and pearl powder are commercially available. In some embodiments, the biomass-derived inorganic extender pigment is preferably an unbaked inorganic extender pigment, more preferably unbaked calcium carbonate, from the viewpoint of processability. Here, the term “unbaked” means that the biomass pigment is not baked at the time when the biomass pigment is obtained. Since the unbaked extender pigment is not subjected to a baking step, it can contribute to reduction in cost and environmental load.

The content of the biomass-derived inorganic extender pigment (for example, calcium carbonate) may be about 50 mass % or more, about 70 mass % or more, or about 90 mass % or more, and about 100 mass % or less, or less than about 100 mass %, with respect to the total amount of the biomass-derived extender pigment derived.

In some embodiments, the average particle size D50 of the biomass-derived extender pigment may be about 100 micrometers or less, preferably about 60 micrometers or less, and more preferably about 40 micrometers or less from the viewpoint of decorativeness. The particle size (D50) of the extender pigment may be measured by using a laser diffraction scattering particle size distribution analyzer “Microtrac MT 3300 EX II series” available from MicrotracBel in a measurement condition in accordance with JIS Z 8825:2013.

Since the biomass-derived extender pigment contains a larger amount of impurities than a virgin extender pigment, the difference from the virgin extender pigment may be evaluated by, for example, thermogravimetry (TG measurement) using a thermal analyzer (TG8120, manufactured by Rigaku Corporation, Akishima City, Tokyo, Japan). TG measurement may be performed by putting about 10 mg of a sample in an aluminum pan under the conditions of a temperature raising rate of 20° C./min and a maximum attainment temperature of 500° C. The mass reduction of the virgin extender pigment is very small, but the mass reduction of the biomass-derived extender pigment is about several %. In addition, since the biomass-derived extender pigment contains a larger amount of impurities than the virgin extender pigment, a larger amount of trace elements are detected. Thus, the difference between the biomass-derived extender pigment and the virgin extender pigment may also be evaluated by comparing the types and detected amounts of trace elements using ICP-MS (ionizing radiation analysis by mass spectrometry). In addition, in an extender pigment derived from seashells, the amount of at least one element selected from the group consisting of magnesium, manganese, phosphorus, and sodium may be observed to be large as compared with a virgin extender pigment of an industrial product (for example, calcium carbonate produced by a carbon dioxide process).

The compounded amount of the biomass-derived extender pigment is, for example, preferably about 5.0 mass % or more, about 10 mass % or more, about 15 mass % or more, about 17 mass % or more, or about 20 mass % or more, about 40 mass % or less, about 35 mass % or less, about 30 mass % or less, or about 28 mass % or less, with respect to the total amount of the colored layer from the viewpoint of flame retardancy, colorability, and the like.

The colored layer of the present disclosure may include at least one selected from the group consisting of a phosphorus-based flame retardant and a boron-based flame retardant in an amount of about 15 mass % or more, about 17 mass % or more, or about 20 mass % or more. The upper limit of the amount may be, for example, about 50 mass % or less, about 45 mass % or less, about 40 mass % or less, or about 35 mass % or less. When either a phosphorus-based flame retardant or a boron-based flame retardant is used alone, the compounded amount is intended to be a single amount, and when a phosphorus-based flame retardant and a boron-based flame retardant are used in combination, the compounded amount is intended to be a total amount thereof. When a phosphorus-based flame retardant and a boron-based flame retardant are used in combination, the blending ratio thereof may be set in the range from, for example, mass ratios of 90:10, 80:20, 70:30, 60:40, 50:50, 40:60, 30:70, 20:80, and 10:90.

Examples of the phosphorus-based flame retardant include monomeric phosphate ester flame retardants typified by triaryl phosphate, and the like, condensed phosphate ester flame retardants typified by resorcinol diphenyl phosphate, bisphenol A diphenyl phosphate, and the like, phosphonate flame retardants, phosphonate metal salt flame retardants, phosphinate flame retardants, phosphinate metal salt flame retardants, red phosphorus, and ammonium polyphosphate. As the ammonium polyphosphate, surface-coated ammonium polyphosphate (for example, melamine-coated ammonium polyphosphate) and the like may also be used. In addition, phosphorus-nitrogen-based flame retardants that may be used in place of melamine polyphosphate, phosphazene compounds, and the like may be exemplified. Of these, from the viewpoint of flame retardancy, phosphinate metal salt, melamine polyphosphate, ammonium polyphosphate, and melamine-coated ammonium polyphosphate are preferable, phosphinate metal salt and melamine polyphosphate are more preferable, and from the viewpoint of water resistance, melamine polyphosphate is particularly preferable. The phosphorus-based flame retardant may be used alone or in combination of two or more types.

The boron-based flame retardant is a flame retardant containing a component containing a boron atom. Examples of the boron-based flame retardant include boric acids, borates, boron-based non-metal compounds, borate minerals, and organic boron-based compounds. Examples of boric acids include boric acid, orthoboric acid, and metaboric acid. Examples of the borates include salts of the above-described boric acids with metal ions or ammonium ions. Of these, examples of the metal species constituting the metal ion include sodium, potassium, calcium, magnesium, barium, aluminum, and zinc. Examples of the boron-based non-metallic compound include boron oxide and boron nitride. Examples of the borate mineral include borax, cholemanite, and urexite. Examples of the organic boron-based compound include a boric acid ester, a borate, and a boroxine. Of these, from the viewpoint of flame retardancy, borates are preferable, a metal salt of boric acid is more preferable, and zinc borate and an alkaline earth metal salt of borate are particularly preferable. The boron-based flame retardants may be used alone or in combination of two or more types.

The colored layer of the present disclosure may include one or more of various resins. Examples of such resins include thermoplastic resins, thermosetting resins, and radiation curable resins. Specific examples thereof include fluorine-based resins, polyester-based resins such as PET and PEN, (meth)acrylic resins, polyolefin-based resins such as polyethylene and polypropylene, thermoplastic elastomers, polycarbonate resins, polyamide resins, ABS resins, acrylonitrile-styrene resins, polystyrene resins, vinyl chloride resins, and resins having a urethane bond. Of these, vinyl chloride resins are preferable from the viewpoint of flame retardancy. Here, in the present disclosure, the “vinyl chloride resin” may include, in addition to a homopolymer of vinyl chloride, a copolymer of a vinyl chloride monomer and another monomer copolymerizable with the vinyl chloride monomer. As the other monomer copolymerizable with the vinyl chloride monomer, known monomers commonly used may be used without any particular limitation. Examples thereof include one or a mixture of two or more of vinyl esters such as vinyl acetate, alkyl vinyl ethers such as ethyl vinyl ether and octyl vinyl ether, α-olefins such as ethylene and propylene, monovalent unsaturated acids such as acrylic acid and methacrylic acid, and alkyl esters such as methyl esters of these monovalent unsaturated acids, divalent unsaturated acids such as maleic acid and itaconic acid, alkyl esters such as methyl esters of these divalent unsaturated acids, vinylidene compounds such as vinylidene chloride, and unsaturated nitriles such as acrylonitrile. The proportion of these monomers used is not particularly limited, and for example, they may be used in a proportion of about 30 mass % or less or about 20 mass % or less with respect to the vinyl chloride monomer.

The colored layer of the present disclosure may contain, fillers, reinforcing materials, antioxidants, UV absorbing agents, flame retardants other than those described above, light stabilizers, heat stabilizers, dispersants, plasticizers, flow improvers, surfactants, leveling agents, silane coupling agents, catalysts, pigments other than those described above, and dyes as optional components in a range that does not negatively affect the effect of the present disclosure. The optional components may be used alone or in combination of two or more types. The individual compounded amount and total compounded amount of the optional components may be decided in a range that does not impair the characteristics required for the colored layer.

The flame-retardant decorative laminate of the present disclosure includes a colored layer containing a biomass-derived extender pigment and containing about 15 mass % or more of at least one selected from the group consisting of a phosphorus-based flame retardant and a boron-based flame retardant, and thus can exhibit excellent flame retardancy. As a result, the colored layer does not have to be blended with another flame retardant, or when another flame retardant is blended, the compounded amount of the flame retardant may be less than about 15 mass %, about 10 mass % or less, about 5 mass % or less, about 3 mass % or less, about 1 mass % or less, or about 0.5 mass % or less, with respect to the total amount of the colored layer.

The thickness of the colored layer may be, for example, about 15 micrometers or more, about 20 micrometers or more, about 23 micrometers or more, or about 25 micrometers or more, and can be about 90 micrometers or less, about 85 micrometers or less, about 80 micrometers or less, about 75 micrometers or less, about 70 micrometers or less, about 65 micrometers or less, or about 60 micrometers or less. From the viewpoint of flame retardancy, the thickness of the colored layer is preferably about 20 micrometers or more and about 85 micrometers or less.

In some embodiments, the colored layer of the present disclosure satisfies a ratio of the thickness of the colored layer to the thickness of the decorative laminate in a range from about 0.20 to about 0.80. When the colored layer of the present disclosure exhibiting flame retardancy satisfies such a ratio, the flame retardancy of the decorative laminate can be further improved. Such a ratio may be about 0.20 or more, about 0.21 or more, or about 0.22 or more, and about 0.80 or less, about 0.70 or less, about 0.60 or less, or about 0.50 or less.

The flame-retardant decorative laminate of the present disclosure includes an adhesive layer. The adhesive layer is typically a layer applied to an adherend, such as a support member of an article which will be described below. The adhesive layer may be transparent or semi-transparent, or may be opaque, that is, have concealing properties. The adhesive layer may be applied partially or over the entire surface to the decorative laminate. The adhesive layer may have a single layer structure or a layered structure.

The adhesive layer may be applied directly or indirectly to one surface of the above-described substrate, that is, the side to be applied to the adherend (the side opposite to the visible side). The application method of the adhesive layer is not particularly limited, and known methods such as knife coating, bar coating, blade coating, doctor coating, roll coating, and cast coating may be used.

The material of the adhesive layer is not particularly limited, and for example, a solvent type, emulsion type, pressure sensitive type, heat sensitive type, thermosetting type, or ultraviolet curing type adhesive using a (meth)acrylic polymer, a polyolefin polymer, a resin having a urethane bond (polyurethane polymer), a polyester polymer, a polyether polymer, a rubber material (for example, natural rubber and synthetic rubber), a silicone polymer, and the like, which are commonly used, may be used. Of such materials, from the viewpoint of ease of bonding to an adherend and the like, a pressure-sensitive adhesive and a heat-sensitive adhesive are preferable, and a pressure-sensitive adhesive and a heat-sensitive adhesive prepared using a (meth)acrylic polymer are more preferable. In the present disclosure, the term “pressure-sensitive adhesive” refers to an adhesive with permanent adhesiveness at room temperature (e.g., about 20° C.) that adheres to various surfaces with light pressure and does not exhibit a phase change (from liquid to solid). Furthermore, the term “heat-sensitive adhesive” is an adhesive that can exhibit adhesiveness (tackiness) by heating.

In the adhesive layer of the present disclosure, as optional components, for example, fillers such as tackifier resins, crosslinking agents, conductive fillers, and thermally conductive fillers, silane coupling agents, plasticizers, thickeners, pigments, dyes, flame retardants, antioxidants, ultraviolet absorbers, stabilizers, and the like may be blended as long as the effect of the present disclosure is not adversely affected. The optional components may be used alone or in combination of two or more types. The individual compounded amount and total compounded amount of the optional components may be decided in a range that does not impair the characteristics required for the adhesive layer.

In some embodiments, the adhesive layer of the present disclosure contains a flame retardant in an amount of about 10 mass % or less, about 5 mass % or less, about 3 mass % or less, about 1 mass % or less, or about 0.5 mass % or less, or the adhesive layer of the present disclosure does not contain a flame retardant. Since the decorative laminate of the present disclosure includes a colored layer containing a biomass-derived extender pigment and containing about 15 mass % or more of at least one selected from the group consisting of a phosphorus-based flame retardant and a boron-based flame retardant, excellent flame retardancy can be exhibited even when the compounded amount of the flame retardant in the adhesive layer is low or no flame retardant is contained in the substrate.

The thickness of the adhesive layer of the present disclosure is not particularly limited, and examples thereof include about 5 micrometers or more, about 10 micrometers or more, or about 20 micrometers or more, and about 100 micrometers or less, about 80 micrometers or less, or about 50 micrometers or less.

In some embodiments, the flame-retardant decorative laminate of the present disclosure optionally includes an additional layer other than the layers described above to the extent that the effect of the present invention is not adversely affected. Examples of the additional layer include at least one selected from the group consisting of a surface layer, a decorative layer (for example, a pattern layer or a relief layer), a bright layer, a bonding layer, and a release liner. The additional layer may be applied to the entire surface or a part of the laminate. The additional layer may have a three-dimensional shape such as an emboss pattern on its surface.

The flame-retardant decorative laminate of the present disclosure includes a colored layer containing a biomass-derived extender pigment and containing about 15 mass % or more of at least one selected from the group consisting of a phosphorus-based flame retardant and a boron-based flame retardant, and thus can exhibit excellent flame retardancy. As a result, the additional layer does not have to be blended with another flame retardant, or when another flame retardant is blended, the compounded amount of the flame retardant may be less than about 15 mass %, about 10 mass % or less, about 5 mass % or less, about 3 mass % or less, about 1 wt. % or less, or about 0.5 mass % or less, with respect to the total amount of each additional layer. In particular, when the surface layer contains a flame retardant at a high concentration, performance such as scratch resistance may deteriorate. In the surface layer of the present disclosure, it is possible to reduce the compounded amount of the flame retardant or not to blend the flame retardant. Thus, it is possible to reduce or suppress deterioration of performance such as scratch resistance during use of a decorative article to which the decorative laminate is applied.

The raw material of the surface layer is not particularly limited, and for example, one type of or a blend of two or more types of (meth)acrylic resins such as polymethyl methacrylate (PMMA) and (meth)acrylic copolymers, resins having a urethane bond (e.g., polyurethane), fluororesins such as ethylene-tetrafluoroethylene copolymers (ETFE), polyvinylidene fluoride (PVDF), and methyl methacrylate-vinylidene fluoride copolymers (PMMA/PVDF), silicone resins, vinyl chloride resins such as polyvinyl chloride (PVC), polycarbonate (PC), polyolefins such as polyethylene (PE) and polypropylene (PP), polyesters such as polyethylene terephthalate (PET) and polyethylene naphthalate (PEN), polyamides such as nylon, and copolymers such as ethylene/acrylic acid copolymers (EAA) and ionomers thereof, ethylene-ethyl acrylate copolymers, ethylene-vinyl acetate copolymers, and ethylene-vinyl alcohol copolymers (EVOH) may be used.

The surface layer may have a multilayer structure. For example, the surface layer may be a laminate of films formed from the resins described above, or may be a multilayer coating of the resins described above. The surface layer may have a three-dimensional uneven shape such as an embossed pattern on the entirety or part of the surface thereof.

The surface layer may be formed, for example, by coating the colored layer or the substrate with the resin composition directly or via a bonding layer or the like. The coating of the surface layer can be performed before application or after application of the decorative laminate to an adherend (e.g., support member described below). Alternatively, the surface layer film may be formed by coating a release liner with a resin composition, and the film can be laminated on the colored layer or the substrate through a bonding layer. For example, in a case where the colored layer is adhesive to the surface layer film, the surface layer film can be directly laminated on the colored layer without any bonding layer to be interposed. For example, the surface layer film can be formed by coating a release liner with a resin raw material such as a curable (meth)acrylic resin composition or a reactive polyurethane composition by knife coating, bar coating, blade coating, doctor coating, roll coating, or cast coating, and then light or heat curing as necessary.

A surface layer formed into a film beforehand through extrusion, stretching, and the like may be used. Such a film can be laminated on the colored layer or the substrate with a bonding layer interposed therebetween. Alternatively, in a case where the colored layer is adhesive to such a film, the film may be directly laminated onto the colored layer without any bonding layer interposed in between. By using a film with high flatness as such a film, an article (structure) can be given an appearance of higher surface flatness. The surface layer can be formed by multilayer extrusion with other layers. For example, a (meth)acrylic film can be used as the other layer. For example, a resin containing polymethyl methacrylate (PMMA), butyl polyacrylate, (meth)acrylic copolymer, ethylene/acrylic copolymer, ethylene vinyl acetate/acrylic copolymer can be formed into a film and used as the (meth)acrylic film. The (meth)acrylic film is excellent in transparency and/or scratch resistance, resistant to heat and/or light, and less likely to cause discoloration and/or changes in gloss. In addition, excellent molding processability is achieved without use of a plasticizer, and excellent contamination resistance is also achieved because use of plasticizer is not required. Among these, a (meth)acrylic film having PMMA as the main component is preferred. For example, in a case where a (meth)acrylic resin having excellent scratch resistance or the like is used as such another layer and a fluororesin having excellent chemical resistance or the like, such as ETFE, PVDF, or PMMA/PVDF, as the surface layer, the formed surface layer can be a surface layer having both performances of these layers.

The surface layer of the present disclosure may contain, as an optional component, for example, a filler, a matting agent, an antioxidant, an ultraviolet absorber, a flame retardant, a light stabilizer, a heat stabilizer, a rheology modifier, a surface conditioner, a hard coat material, a gloss imparting agent, a dispersant, a plasticizer, a flow improver, a surfactant, a leveling agent, a silane coupling agent, a catalyst, a pigment, a dye, and the like as long as the effect of the present disclosure is not adversely affected. Of these, for example, use of UV absorbing agents such as benzotriazole, Tinuvin (tradename) 1130 (available from BASF), and hindered amine light stabilizers (HALS) such as Tinuvin (tradename) 292 (available from BASF) can effectively prevent discoloration, fading, and deterioration of the colored layer located as a lower layer. Rheology modifiers such as ACRYSOL (tradename) RM-8W, surfactants such as Dynol (tradename) 604, and the like may also be used to improve coatability. The hard coat material may be contained in the surface layer, or may be applied as a hard coat layer by separately coating on the surface layer.

The surface layer may be partially opaque, but is preferably translucent or semi-transparent from the viewpoint of visibility for the colored layer or any decorative layer.

The thickness of the surface layer is not particularly limited, and may be, for example, about 1 micrometer or more, about 5 micrometers or more, or about 10 micrometers or more, and may be about 150 micrometers or less, about 100 micrometers or less, about 80 micrometers or less, about 50 micrometers or less, about 30 micrometers or less, or about 20 micrometers or less. From the viewpoint of flame retardancy, it is advantageous that the surface layer is thin, and for example, it is preferably about 50 micrometers or less, about 30 micrometers or less, or about 20 micrometers or less.

In some embodiments, the surface layer includes a matting agent. By blending a matting agent, the surface layer can exhibit matting properties. Here, in the present disclosure, “matte properties” are intended to exhibit low surface glossiness compared to a surface layer that does not include a matting agent.

The matte properties may be evaluated, for example, with 60-degree surface glossiness, that is, a surface glossiness at 60 degrees. In some embodiments, the surface layer of the decorative laminate of the present disclosure exhibits a 60-degree surface glossiness of about 10.0 GU or less, about 8.0 GU or less, about 5.0 GU or less, about 4.5 GU or less, or about 4.0 GU or less. The lower limit of the surface glossiness is not particularly limited, and can be, for example, about 0.1 GU or more, about 0.5 GU or more, or about 1.0 GU or more. The surface glossiness is a value measured using a portable glossmeter GMX-203 (Murakami Color Research Laboratory, Chuo-ku, Tokyo, Japan).

As the matting agent, resin beads and inorganic particles may be used, for example. The matting agent may be used alone or in combination of two or more types.

The resin beads are not particularly limited, and examples thereof include resin beads prepared from a resin having a urethane bond, a styrene resin, a nylon resin, a polyester resin, a melamine resin, a silicone resin, and a (meth)acrylic resin. The resin beads may be solid or may have voids, and may be used alone or in combination of two or more types. Of these, from the viewpoint of the matte properties and scratch resistance, the followability when the surface layer is stretched, and the like, the resin beads containing a resin having a urethane bond (sometimes referred to as “urethane resin beads”) are preferable. The surface of the resin beads may be modified with a known surface modification agent.

As the urethane resin beads, crosslinked urethane resin beads obtained by suspension polymerization, seed polymerization, emulsion polymerization, or the like can be used. Such urethane resin beads have excellent flexibility, toughness, scratch resistance, and the like, and these characteristics can be imparted to the surface layer.

When the resin beads and the binder are the same type of resin components, for example, in a case of resin beads and a binder containing a urethane component or resin beads and a binder containing a (meth)acrylic component, such resin beads have excellent affinity with the binder and, therefore, adhesion with the binder can be improved. As a result, even if the laminate is stretched or deformed, the detachment of the resin beads from the binder can be reduced or suppressed. Here, the “same type of resin components” are not limited to a case where the constituent components of the resin are completely the same, and include a case where one or more common resin components are present in the components constituting the resin. For example, resin beads prepared from urethane acrylate have two types of urethane component and acrylic component, and therefore, such resin beads are the same types of resin components as the urethane resin binder, and are also the same types of resin components as the acrylic resin binder.

In addition to the scattering effect of light based on the convexities and concavities of the surface layer surface, in a case where scattering or refractive effects of light due to the resin beads within the surface layer are expected, the refractive index of the resin beads is preferably different from the refractive index of the binder.

The inorganic particles are not particularly limited, and examples thereof include inorganic oxide particles, mixed oxide particles containing two or more types of metal elements, and mixtures thereof. Examples of the inorganic oxide particles include at least one selected from the group consisting of alumina particles, tin oxide particles, antimony oxide particles, silica particles, zirconia particles, titania particles, and ferrite particles. Examples of the mixed oxide particles containing two or more metal elements include mixed oxide particles containing at least two metal elements selected from the group consisting of aluminum, tin, antimony, silicon, zirconium, titanium, and iron. The inorganic particles may be used alone or in combination of two or more types. Of these, alumina particles are preferable from the viewpoint of matting properties and scratch resistance.

The average particle size of the matting agent may be about 3 micrometers or more, about 5 micrometers or more, about 7 micrometers or more, about 10 micrometers or more, about 15 micrometers or more, about 16 micrometers or more, about 18 micrometers or more, about 20 micrometers or more, about 23 micrometers or more, or about 25 micrometers or more, and may be about 50 micrometers or less, about 45 micrometers or less, about 40 micrometers or less, about 35 micrometers or less, about 30 micrometers or less, about 25 micrometers or less, about 20 micrometers or less, about 18 micrometers or less, about 17 micrometers or less, about 16 micrometers or less, about 15 micrometers or less, about 14 micrometers or less, about 13 micrometers or less, about 12 micrometers or less, about 11 micrometers or less, or about 10 micrometers or less. The average particle size of the matting agent is a particle size having cumulative volume of 50% measured by using a laser diffraction particle size distribution measuring device.

The compounded amount of the matting agent may be about 10 mass % or more, about 20 mass % or more, about 30 mass % or more, about 40 mass % or more, about 45 mass % or more, or about 50 mass % or more, and can be about 70 mass % or less, about 65 mass % or less, about 60 mass % or less, about 55 mass % or less, or about 50 mass % or less with respect to the total amount of the surface layer.

The decorative layer as an additional layer means a layer that can impart decoration besides decoration by the colored layer described above. Examples of such a decorative layer include, but are not limited to, a pattern layer for imparting a pattern such as wood grain, stone grain, geometric pattern, or leather pattern, a logo, or a pattern to an article, a relief (relief pattern) layer having an uneven shape on a surface thereof, and a combination thereof.

The decorative layer can be applied to, but not limited to, the entire face of or a part of a layer constituting the decorative laminate, such as the surface layer, the colored layer, the substrate, or the adhesive layer, directly or through a bonding layer.

The pattern layer is not limited to the following but, for example, a pattern layer obtained by directly applying a pattern, such as a design pattern, a logo, or a picture pattern, on the surface layer, the metallic layer, or the adhesive layer, using a printing method, such as gravure direct printing, gravure offset printing, inkjet printing, laser printing, or screen printing, may be employed. Alternatively, for example, a film or a sheet having a design pattern, a logo, or a picture pattern, formed by coating, such as gravure coating, roll coating, die coating, bar coating, or knife coating, punching, or etching may be also used.

The raw material for the pattern layer is not limited to the following, but for example, a raw material obtained by dispersing a pigment in a binder resin, such as a (meth)acrylic resin or a resin having a urethane bond, can be used. Examples of the pigment include inorganic pigments, such as carbon black, chrome yellow, yellow iron oxide, colcothar, or red iron oxide; or organic pigments, such as a phthalocyanine pigment such as phthalocyanine blue or phthalocyanine green, an azo lake pigment, an indigo pigment, a perinone pigment, a perylene pigment, a quinophthalone pigment, a dioxazine pigment, and a quinacridone pigment such as quinacridone red.

For the relief layer, a thermoplastic resin film having an uneven shape on the surface may be used, the uneven shape being obtained by a well-known method in the art, such as, for example, emboss finishing, scratch processing, laser processing, dry etching processing, or hot press processing. The relief layer may be also formed by applying a thermosetting or radiation-curable resin, such as a curable (meth)acrylic resin, on a release liner having an uneven shape, curing the resin by heat or radiation, and removing the release liner.

The thermoplastic resin, thermosetting resin, and radiation-curable resin used in the relief layer are not particularly limited but, for example, a fluororesin, a polyester resin such as PET or PEN, a (meth)acrylic resin, a polyolefin resin such as polyethylene or polypropylene, a thermoplastic elastomer, a polycarbonate resin, a polyamide resin, an ABS resin, an acrylonitrile-styrene resin, a polystyrene resin, a vinyl chloride resin, or a resin having a urethane bond can be used. The relief layer may contain at least one of the pigments used in the pattern layer.

The decorative layer of the present disclosure can contain, for example, fillers, reinforcing agents, antioxidants, UV absorbing agents, flame retardants, light stabilizers, heat stabilizers, dispersants, plasticizers, flow improvers, surfactants, leveling agents, silane coupling agents, and catalysts as optional components in a range that does not negatively affect the effect of the present disclosure.

The thickness of the decorative layer is only required to be appropriately adjusted according to the required decorativeness or the like and not particularly limited but, for example, may be about 1.0 micrometer or more, about 3.0 micrometers or more, or about 5.0 micrometers or more, and can be about 50 micrometers or less, about 40 micrometers or less, or about 30 micrometers or less.

Examples of the brightening layer may include, but are not limited to, layers constituting the decorative laminate, for example, layers containing a metal selected from aluminum, nickel, gold, silver, copper, platinum, chromium, iron, tin, indium, titanium, lead, zinc, or germanium, or an alloy or compound thereof, formed by vacuum deposition, sputtering, ion plating, plating, or the like on the entire surface or a part of the substrate or the colored layer. The thickness of the brightening layer may be appropriately selected in accordance with the required decorativeness, brightness, and the like.

In the flame-retardant decorative laminate of the present disclosure, a bonding layer (sometimes referred to as “primer layer”, for example) may be used to bond an additional layer in the laminate. As the bonding layer, a solvent type, emulsion type, pressure-sensitive, heat-sensitive, thermosetting, or ultraviolet-curable adhesive such as a generally used (meth)acryl-based polymer, polyolefin-based polymer, resin having a urethane bond (polyurethane-based polymer), polyester-based polymer, or rubber-based material may be used. The bonding layer may be applied by a well-known coating method or the like.

In the flame-retardant decorative laminate of the present disclosure, a release liner may be typically applied to the adhesive layer. Examples of the release liner include paper; a plastic material such as polyethylene, polypropylene, polyester (e.g., PET), and cellulose acetate; and paper coated with such a plastic material. These liners may have a surface that has been subjected to release treatment with a release agent such as silicone. The thickness of the release liner, generally, can be about 5 micrometers or more, about 15 micrometers or more, or about 25 micrometers or more, and can be about 500 micrometers or less, about 300 micrometers or less, or about 250 micrometers or less.

The flame-retardant decorative laminate of the present disclosure may be, for example, a sheet-like article, a rolled body winded in a roll shape, or an article with a three-dimensional shape.

The following production method is described as an example, but the method of producing a flame-retardant decorative laminate is not limited thereto.

For example, in the case of a laminate having a configuration in which a release liner, an adhesive layer, a substrate, a colored layer, and a surface layer are provided in this order, the adhesive is coated on the substrate, a drying step and a curing step are applied as necessary, and then the release liner is bonded to the adhesive layer to form laminate A. A substrate surface of the laminate A is coated with a composition for a colored layer containing a biomass-derived extender pigment and a specific flame retardant, and as necessary, a drying step and a curing step are applied to form a colored layer, and then the composition for a surface layer is coated on the colored layer, and as necessary, a drying step and a curing step are applied to form a surface layer, whereby a decorative laminate may be formed. Alternatively, the colored layer may be applied to the substrate, the adhesive may then be applied to the colored layer, and the surface layer may then be applied to the side of the substrate opposite the adhesive layer.

In some embodiments, a decorative article is provided including a support member and the flame-retardant decorative laminate of the present disclosure adhered to the support member. Such a decorative article can exhibit flame retardancy. The material for the support member is not particularly limited, and examples thereof include resin raw materials (e.g., polyolefin resins, polyester resins, (meth)acrylic resins, polycarbonate resins, and acrylonitrile-butadiene-styrene copolymers), inorganic raw materials (e.g., glass, ceramic, concrete, gypsum, calcium silicate, natural stone, and asphalt), rubber raw materials, cloth materials (e.g., woven fabrics, knitted fabrics, and nonwoven fabrics), and woody raw materials.

The shape or configuration of the support member is not particularly limited: it may be, for example, film shape, plate shape, curved surface shape, deformed shape, or three-dimensional shape, and it can also be single-layer configuration, laminated configuration, or composite configuration such as in which plural members in different shapes materials are combined.

The article to which the decorative laminate of the present disclosure is applied may be used for various purposes. Examples of such purposes include signboards (e.g., internally illuminated signboards and externally illuminated signboards); signs (e.g., internally illuminated signs and externally illuminated signs); various interior or exterior articles such as interior or exterior articles for vehicles, such as automobiles, railways, aircrafts, and ships (e.g., roof members; pillar members; door trim members; instrument panel members; front members, such as hoods; bumper members; fender members; side sill members; and interior panel members); and interior products or exterior products of buildings (e.g., window glass, doors, sashes, roof members such as tiling, outer wall members, and wall papers); electrical appliances, such as personal computers, smartphones, cellular phones, refrigerators, and air conditioners; stationery; furniture; desks; and various containers such as cans. Of these, since the decorative laminate of the present disclosure is excellent in flame retardancy, an article to which the decorative laminate of the present disclosure is applied can be suitably used as an interior article or an exterior article of buildings.

The method for applying the flame-retardant decorative laminate of the present disclosure to a support member (adherend) constituting a decorative article is not particularly limited, and a known method may be appropriately used. Examples of the method include hand application, injection molding methods such as an insert injection molding method, an in-molding method, an over-molding method, a two-color injection molding method, a core back injection molding method, and a sandwich injection molding method, a lamination method, and a three-dimensional heat stretch blow molding method (TOM).

### EXAMPLES

In the following examples, specific embodiments of the present disclosure will be illustrated, but the present invention is not limited to these examples. All ‘part’ and ‘percent’ are based on mass unless otherwise specified. A numerical value essentially includes an error originated from a measurement principle and a measuring device. The numerical value is generally indicated by a significant digit that is rounded.

The products used in this example are shown in Table 1 below.

TABLE 1

| Product name, model number, or | | |
|---|---|---|
| abbreviated name | Description | Available from |
| ETERNACOLL (tradename) | Polyurethane dispersion (material | UBE Corporation (Minato-ku, Tokyo, |
| UW-1005E | obtained by dispersing | Japan) |
| | polyurethane resin in water) | |
| | Elastic modulus 20 MPa | |
| Art Pearl (tradename) C-800T | Urethane resin beads, average | Negami Chemical Industrial Co., Ltd. |
| | particle size: 6 μm | (Nomi-shi, Ishikawa, Japan) |
| Takenate (tradename) WB-3936 | Aqueous blocked isocyanate | Mitsui Chemicals, Inc. (Minato-ku, |
| | | Tokyo, Japan) |
| Vinyl chloride resin | Vinyl chloride-vinyl acetate | Dainichiseika Color & Chemicals Mfg. |
| | copolymer containing resin | Co., Ltd. (Chuo-ku, Tokyo, Japan) |
| Pigment (white) | White (CAS: 13463-67-7) pigment | Dainichiseika Color & Chemicals Mfg. |
| | | Co., Ltd. (Chuo-ku, Tokyo, Japan) |
| Pigment (blue) | Blue (CAS: 147-14-8) pigment | Dainichiseika Color & Chemicals Mfg. |
| | | Co., Ltd. (Chuo-ku, Tokyo, Japan) |
| Extender pigment | Unbaked calcium carbonate | N.C. CORPORATION (Itano-gun, |
| | extender pigment with 100% | Tokushima Prefecture, Japan) |
| | scallop shells | |
| | (Scallop powder S) | |
| Phosphorus-based flame | Phosphinate metal salt | Clariant Japan K.K. (Bunkyo-ku, |
| retardant | | Tokyo, Japan) |
| (EXOLIT (tradename) OP935) | | |
| Phosphorus-based flame | Melamine polyphosphate | CBC Corporation (Chuo-ku, Tokyo, |
| retardant (BUDIT341) | | Japan) |
| Phosphorus-based flame | Aluminum phosphate | Clariant Japan K.K. (Bunkyo-ku, |
| retardant (AP423) | | Tokyo, Japan) |
| Phosphorus-based flame | Melamine-coated ammonium | CBC Corporation (Chuo-ku, Tokyo, |
| retardant (TERRAJU C-30) | polyphosphate | Japan) |
| Inorganic flame retardant | Zinc boride | U.S. Borax Inc. (Boron, CA, USA) |
| (Firebrake (tradename) ZB-XF) | | |
| Inorganic flame retardant (BF- | Aluminum hydroxide | Nippon Light Metal Co., Ltd. (Minato- |
| 083) | | ku, Tokyo, Japan) |
| Inorganic flame retardant (BF- | Aluminum hydroxide | Nippon Light Metal Co., Ltd. (Minato- |
| 013) | | ku, Tokyo, Japan) |
| MEK | Methyl ethyl ketone | FUJIFILM Wako Pure Chemical |
| | | Corporation (Osaka-shi, Osaka, Japan) |
| RESHINE (tradename) TA-065 | Transparent PET film of 50 μm | Toyobo Co., Ltd. (Osaka, Japan) |
| | thick in which recycled raw | |
| | material of PET bottle is used in | |
| | 50% or more | |

### Examples 1 to 15 and Comparative Examples 1 to 5

Production of PET Film Substrate Provided with Colored Layer

A formulation containing each component constituting the colored layer shown in Table 2 and methyl ethyl ketone (MEK) were mixed for about 3 minutes with THINKY (tradename) AR-250 (manufactured by THINKY CORPORATION (Chiyoda-ku, Tokyo, Japan)) to obtain a coating solution for a colored layer. This coating solution was applied onto a transparent PET film substrate containing recycled PET (RESHINE (tradename) TA-065) by knife coating. Drying was performed at about 65° C. for about 1.5 minutes and at about 155° C. for about 2 minutes to obtain a PET film substrate having a colored layer. The thickness of the colored layer employed in each Example and Comparative Example is shown in Table 2.

### Example 1

A formulation containing 20 parts by mass of ETERNACOLL (tradename) UW-1005E, 15 parts by mass of Art Pearl (tradename)C-800T, 18 parts by mass of Takenate (tradename) WB-3936, 34 parts by mass of pure water, 7 parts by mass of isopropyl alcohol (IPA), 3 parts by mass of a rheology modifier, and 3 parts by mass of a surfactant was mixed in THINKY (tradename) AR-250 (manufactured by THINKY CORPORATION, Chiyoda City, Tokyo, JP) for about 2 minutes to obtain a surface layer coating solution. The coating liquid was applied onto the colored layer of the PET film substrate provided with the colored layer by knife coating. Drying was performed at about 65° C. for about 2 minutes and at about 150° C. for about 5 minutes to form a surface layer of about 12 micrometers thick.

A monomer mixture of butyl acrylate and acrylate was copolymerized in ethyl acetate to prepare an acrylic pressure-sensitive adhesive composition containing about 38 mass % of an acrylic copolymer. The obtained composition was applied by knife coating to a surface of the PET film substrate opposite to the surface to which the colored layer was applied so that the thickness after drying was about 38 micrometers, whereby a decorative laminate was produced. In Table 2, the layer configuration of the laminate is classified into the following three groups, and the layer configuration of Example 1 corresponds to the layer configuration A:
Layer configuration A: surface layer/colored layer/PET substrate/adhesive layer
Layer configuration B: surface layer/PET substrate/colored layer/adhesive layer
Layer configuration C: colored layer/PET substrate/adhesive layer

### Examples 2 to 7 and Comparative Examples 1 to 3

Decorative laminates were produced in the same manner as in Example 1 except that the composition and the thickness of the colored layer were changed to the materials shown in Table 2.

### Example 8

The surface layer coating liquid obtained in Example 1 was applied by knife coating to the surface of the PET film substrate provided with the colored layer opposite to the surface to which the colored layer was applied. Drying was performed at about 65° C. for about 2 minutes and at about 150° C. for about 5 minutes to form a surface layer of about 14 micrometers thick. Next, the acrylic pressure sensitive adhesive composition obtained in Example 1 was applied onto the colored layer by knife coating so that the thickness after drying was about 38 micrometers to prepare a decorative laminate.

### Examples 9, 10 and 12 to 15

Decorative laminates were produced in the same manner as in Example 8 except that the composition and the thickness of the colored layer were changed as shown in Table 2.

### Example 11

A PET film substrate provided with a colored layer was prepared so as to have the composition and thickness shown in Table 2. Next, the acrylic pressure-sensitive adhesive composition obtained in Example 1 was applied by knife coating to the surface of the PET film substrate opposite to the surface to which the colored layer was applied so that the thickness after drying was about 38 micrometers, whereby a decorative laminate was produced.

### Comparative Example 4

A decorative laminate was produced in the same manner as in Example 11 except that the composition of the colored layer was changed as shown in Table 2.

### Comparative Example 5

A decorative laminate was produced in the same manner as in Example 1 except that the thickness of the surface layer, and the composition and thickness of the colored layer were changed as shown in Table 2.

### Physical Property Evaluation Test

The properties of each decorative laminate were evaluated by the following tests. The results are shown in Table 2.

### (Heat Release Test: Flame Retardancy)

Each decorative laminate cut into a 99 mm+1 mm square was superposed on a 12.5 mm-thick plasterboard cut into a 99 mm+1 mm square that is a noncombustible material specified in Notification No. 1400 of the Ministry of Construction in 2000 to prepare a test piece.

The test piece was allowed to stand in an environment of 23° C. and 50% RH for one week or more, and then subjected to a heat release test using a cone calorimeter (manufactured by Toyo Seiki Seisaku-sho, Ltd., Kita-ku, Tokyo, Japan) in accordance with ISO 5660-1:2002, cone calorimetry, in which the total calorific value was measured under a condition that radiant heat applied to a test piece surface on the decorative laminate side is 50 kW/m². From this test, the total calorific value (THR), the maximum heat release rate (PHRR) and the time over which the 200 kW/2 of the test piece was exceeded during a test time of 20 minutes were each determined. The results are shown in Table 2.

### (60 Degree Glossiness Test: Matting Property)

The 60-degree glossiness of the surface layer or the colored layer of the decorative laminate was measured with a portable gloss meter GMX-203 manufactured by MURAKAMI COLOR RESEARCH LABORATORY in accordance with JIS Z8741. The measurements of the gloss were performed at three points, and the average value was used as the representative value. The results are shown in Table 2.

TABLE 2

| | | Layer configuration | | | | | | | |
|---|---|---|---|---|---|---|---|---|---|
| | | A | A | A | A | A | A | A | B |
| | | Example | Example | Example | Example | Example | Example | Example | Example |
| | Material | 1 | 2 | 3 | 4 | 5 | 6 | 7 | 8 |
| colored | Vinyl chloride resin | 50.9 | 36.4 | 42.8 | 42.8 | 42.8 | 30.0 | 30.0 | 30.0 |
| layer | Pigment (white) | 13.3 | 13.2 | 10.0 | 10.0 | 10.0 | 18.7 | 18.7 | 18.7 |
| | Pigment (blue) | | | | | | | | |
| | Biomass-derived extender | 20.4 | 20.2 | 25.1 | 25.1 | 25.1 | 20.5 | 20.5 | 20.5 |
| | pigment | | | | | | | | |
| | Phosphorus-based flame | 15.3 | 30.2 | | | | | | |
| | retardant | | | | | | | | |
| | (EXOLIT (tradename) OP935: | | | | | | | | |
| | phosphinate metal salt) | | | | | | | | |
| | Phosphorus-based flame | | | | | | | | |
| | retardant (BUDIT341: | | | | | | | | |
| | melamine polyphosphate) | | | | | | | | |
| | Phosphorus-based flame | | | | 22.1 | 11.0 | | | 30.8 |
| | retardant (AP423: ammonium | | | | | | | | |
| | polyphosphate) | | | | | | | | |
| | Phosphorus-based flame | | | | | | 15.4 | 30.8 | |
| | retardant | | | | | | | | |
| | (TERRAJU C-30: melamine- | | | | | | | | |
| | coated ammonium | | | | | | | | |
| | polyphosphate) | | | | | | | | |
| | Inorganic flame retardant | | | 22.1 | | 11.0 | 15.4 | | |
| | (Firebrake (tradename) ZB- | | | | | | | | |
| | XF: zinc borate) | | | | | | | | |
| | Inorganic flame retardant (BF- | | | | | | | | |
| | 083: aluminum hydroxide) | | | | | | | | |
| | Inorganic flame retardant (BF- | | | | | | | | |
| | 013: aluminum hydroxide) | | | | | | | | |
| | Total | 100 | 100 | 100 | 100 | 100 | 100 | 100 | 100 |
| Compounded amount (mass %) of flame | | 15.3 | 30.2 | 22.1 | 22.1 | 22.1 | 30.8 | 30.8 | 30.8 |
| retardant in colored layer | | | | | | | | | |
| Thickness of colored layer (μm) | | 29 | 31 | 30 | 30 | 28 | 34 | 36 | 30 |
| Total thickness of laminate (μm) | | 129 | 131 | 130 | 130 | 128 | 134 | 136 | 132 |
| Ratio of thickness of colored layer/total | | 22% | 24% | 23% | 23% | 22% | 25% | 26% | 23% |
| thickness of laminate | | | | | | | | | |
| Evaluation | Total calorific value (MJ/m²) | 7.4 | 6.1 | 7.1 | 5.7 | 5.7 | 7.1 | 6.9 | 8.0 |
| results | Maximum heat release rate | 180 | 153 | 163 | 172 | 180 | 163 | 196 | 144 |
| | (kW/m²) | | | | | | | | |
| | Time to exceed 200 kW/m² | 0 | 0 | 0 | 0 | 0 | 0 | 0 | 0 |
| | (second) | | | | | | | | |
| | 60 Degree glossiness (GU) | 2.3 | 2.2 | 1.9 | 1.9 | 1.9 | 2.0 | 2.3 | 2.1 |

| | | Layer configuration | | | | | | |
|---|---|---|---|---|---|---|---|---|
| | | B | B | C | B | B | B | B |
| | | Example | Example | Example | Example | Example | Example | Example |
| | Material | 9 | 10 | 11 | 12 | 13 | 14 | 15 |
| colored | Vinyl chloride resin | 30.0 | 30.0 | 47.4 | 54.0 | 38.3 | 45.1 | 45.1 |
| layer | Pigment (white) | 18.7 | 18.7 | | | 21.7 | 14.6 | 14.6 |
| | Pigment (blue) | | | | 5.9 | | | |
| | Biomass-derived extender | 20.5 | 20.5 | 26.3 | 20.1 | 20.0 | 20.1 | 20.1 |
| | pigment | | | | | | | |
| | Phosphorus-based flame | 30.8 | 30.8 | 26.3 | | | | |
| | retardant | | | | | | | |
| | (EXOLIT (tradename) OP935: | | | | | | | |
| | phosphinate metal salt) | | | | | | | |
| | Phosphorus-based flame | | | | 20.1 | 20.0 | 20.1 | 20.1 |
| | retardant (BUDIT341: | | | | | | | |
| | melamine polyphosphate) | | | | | | | |
| | Phosphorus-based flame | | | | | | | |
| | retardant (AP423: ammonium | | | | | | | |
| | polyphosphate) | | | | | | | |
| | Phosphorus-based flame | | | | | | | |
| | retardant | | | | | | | |
| | (TERRAJU C-30: melamine- | | | | | | | |
| | coated ammonium | | | | | | | |
| | polyphosphate) | | | | | | | |
| | Inorganic flame retardant | | | | | | | |
| | (Firebrake (tradename) ZB- | | | | | | | |
| | XF: zinc borate) | | | | | | | |
| | Inorganic flame retardant (BF- | | | | | | | |
| | 083: aluminum hydroxide) | | | | | | | |
| | Inorganic flame retardant (BF- | | | | | | | |
| | 013: aluminum hydroxide) | | | | | | | |
| | Total | 100 | 100 | 100 | 100 | 100 | 100 | 100 |
| Compounded amount (mass %) of flame | | 30.8 | 30.8 | 26.3 | 20.1 | 20.0 | 20.1 | 20.1 |
| retardant in colored layer | | | | | | | | |
| Thickness of colored layer (μm) | | 38 | 25 | 53 | 30 | 59 | 70 | 82 |
| Total thickness of laminate (μm) | | 140 | 127 | 141 | 132 | 161 | 172 | 184 |
| Ratio of thickness of colored layer/total | | 27% | 20% | 38% | 23% | 37% | 41% | 45% |
| thickness of laminate | | | | | | | | |
| Evaluation | Total calorific value (MJ/m²) | 7.4 | 6.7 | 7.1 | 7.4 | 6.6 | 7.9 | 7.7 |
| results | Maximum heat release rate | 186 | 167 | 189 | 138 | 153 | 122 | 124 |
| | (kW/m²) | | | | | | | |
| | Time to exceed 200 kW/m² | 0 | 0 | 0 | 0 | 0 | 0 | 0 |
| | (second) | | | | | | | |
| | 60 Degree glossiness (GU) | 2.4 | 2.3 | 4.4 | 0.5 | 2.2 | 2.3 | 2.3 |

| | | Layer configuration | | | | |
|---|---|---|---|---|---|---|
| | | A | A | A | C | A |
| | | Comparative | Comparative | Comparative | Comparative | Comparative |
| | Material | Example 1 | Example 2 | Example 3 | Example 4 | Example 5 |
| colored | Vinyl chloride resin | 59.8 | 41.1 | 41.1 | 66.5 | 45.1 |
| layer | Pigment (white) | | 17.6 | 17.6 | | 14.6 |
| | Pigment (blue) | | | | | |
| | Biomass-derived extender | 40.2 | 41.3 | 41.3 | | 20.1 |
| | pigment | | | | | |
| | Phosphorus-based flame | | | | | |
| | retardant | | | | | |
| | (EXOLIT (tradename) OP935: | | | | | |
| | phosphinate metal salt) | | | | | |
| | Phosphorus-based flame | | | | | |
| | retardant (BUDIT341: | | | | | |
| | melamine polyphosphate) | | | | | |
| | Phosphorus-based flame | | | | | |
| | retardant (AP423: ammonium | | | | | |
| | polyphosphate) | | | | | |
| | Phosphorus-based flame | | | | | |
| | retardant | | | | | |
| | (TERRAJU C-30: melamine- | | | | | |
| | coated ammonium | | | | | |
| | polyphosphate) | | | | | |
| | Inorganic flame retardant | | | | | |
| | (Firebrake (tradename) ZB- | | | | | |
| | XF: zinc borate) | | | | | |
| | Inorganic flame retardant (BF- | | | | 33.5 | |
| | 083: aluminum hydroxide) | | | | | |
| | Inorganic flame retardant (BF- | | | | | 20.1 |
| | 013: aluminum hydroxide) | | | | | |
| | Total | 100 | 100 | 100 | 100 | 100 |
| Compounded amount (mass %) of flame | | 0 | 0 | 0 | 33.5 | 20.1 |
| retardant in colored layer | | | | | | |
| Thickness of colored layer (μm) | | 29 | 18 | 33 | 53 | 60 |
| Total thickness of laminate (μm) | | 129 | 118 | 133 | 141 | 162 |
| Ratio of thickness of colored layer/total | | 22% | 15% | 25% | 38% | 37% |
| thickness of laminate | | | | | | |
| Evaluation | Total calorific value (MJ/m²) | 9.0 | 8.6 | 9.1 | 8.1 | 8.1 |
| results | Maximum heat release rate | 153 | 150 | 132 | 243 | 142 |
| | (kW/m²) | | | | | |
| | Time to exceed 200 kW/m² | 0 | 0 | 0 | 9 | 0 |
| | (second) | | | | | |
| | 60 Degree glossiness (GU) | — | 0.8 | 0.8 | 35.9 | 2.4 |

Various variations of the above-mentioned embodiments and examples will be apparent to those skilled in the art without departing from the basic principle of the present invention. In addition, it is apparent for a person skilled in the art that various modifications and variations of the present invention can be made without departing from the spirit and scope of the present invention.

1. A flame-retardant decorative laminate comprising a substrate, a colored layer, and an adhesive layer,
the colored layer comprising a biomass-derived extender pigment and containing 15 mass % or more of at least one selected from the group consisting of a phosphorus-based flame retardant and a boron-based flame retardant.

2. The flame-retardant decorative laminate according to claim 1, wherein the colored layer has a thickness of 20 micrometers or more and 85 micrometers or less, the flame-retardant decorative laminate has a thickness of 200 micrometers or less, and a ratio of the thickness of the colored layer to the thickness of the flame-retardant decorative laminate is from 0.20 to 0.80.

3. The flame-retardant decorative laminate according to claim 1, wherein a compounded amount of a flame retardant in the substrate is 10 mass % or less.

4. The flame-retardant decorative laminate according to claim 1, wherein the colored layer contains a vinyl chloride resin.

5. The flame-retardant decorative laminate according to claim 1, wherein the substrate contains a polyethylene terephthalate resin.

6. The flame-retardant decorative laminate according to claim 5, wherein the polyethylene terephthalate resin contains a recycled polyethylene terephthalate resin.

7. The flame-retardant decorative laminate according to claim 1, wherein the biomass-derived extender pigment contains biomass-derived calcium carbonate.

8. The laminate according to claim 1, wherein in a Heat Release Test mentioned below using a test piece that is a laminated plate including a plasterboard and the laminate, the laminate being stacked on a side of the plasterboard, the side being subjected to radiant heat, a total calorific value of the test piece during a test time of 20 minutes is 8.0 MJ/m² or less:
Heat Release Test: heat release test according to ISO 5660-1:2002, cone calorimetry, wherein the total calorific value is measured under a condition that radiant heat applied to a test piece surface is 50 kW/m².

9. A decorative article comprising:
a support member, and the flame-retardant decorative laminate described in claim 1 bonded to the support member.
